(19) United States
(12) Patent Application Publication
(10) Pub. No.: US 2019/0007613 A1
(43) Pub. Date: Jan. 3, 2019

(54) IMAGE ACQUISITION

(71) Applicant: Lenovo (Beijing) Co., Ltd., Beijing (CN)

(72) Inventor: Jiefeng CHEN, Beijing (CN)

(21) Appl. No.: 15/918,151

(22) Filed: Mar. 12, 2018

(30) Foreign Application Priority Data
Jun. 30, 2017 (CN) 201710530914.2

(51) Int. Cl. H04N 5/232; H04N 5/225; H04N 5/33

(52) U.S. Cl. CPC H04N 5/23245; H04N 5/2253; H04N 5/2254; H04N 5/332; H04N 5/2257

(57) ABSTRACT

An image acquisition apparatus includes a lens and a photosensitive array including at least a plurality of first type pixels and a plurality of second type pixels. The plurality of first type pixels and the plurality of second type pixels are different from each other and implement different functions.

### CROSS-REFERENCE TO RELATED APPLICATION

This application claims priority to Chinese Application No. 201710530914.2, filed on Jun. 30, 2017, the entire contents of which are incorporated herein by reference.

### FIELD OF THE DISCLOSURE

The present disclosure relates to an image acquisition apparatus and method, and an electronic device.

### BACKGROUND

With portable devices becoming more popular, functions provided by the portable devices are becoming more diversified. A camera is commonly provided in a portable device, for example, a smartphone, to facility a user to capture images anytime and anywhere. Additional applications, such as depth-of-field (DoF) calculation, iris recognition, or the like, are provided by using the camera of the portable device. The DoF refers to the range of distances from the lens of the camera or another imager in which a photographed object can be focused to obtain a clear image. Iris recognition technologies identify the identity of an individual based on the iris pattern thereof, which can be used in highly confidential places. For example, iris recognition function can be provided in a smartphone. When the smartphone is locked, only the user himself can unlock the smartphone through iris recognition.

However, a dedicated camera module or a DoF camera is needed to achieve the above described applications, which leads to an increase in the size and cost of the portable device. Furthermore, the increased size of the portable device affects the portability thereof.

### SUMMARY

In accordance with the disclosure, there is provided an image acquisition apparatus including a lens and a photosensitive array including at least a plurality of first type pixels and a plurality of second type pixels. The plurality of first type pixels and the plurality of second type pixels are different from each other and implement different functions.

Also in accordance with the disclosure, there is provided an electronic device including an image acquisition apparatus and a processor coupled to the image acquisition apparatus. The image acquisition apparatus includes a lens and a photosensitive array including at least a plurality of first type pixels and a plurality of second type pixels. The plurality of first type pixels and the plurality of second type pixels are different from each other and implement different functions. The processor performs calculation using at least data selected from the group including data collected by the plurality of first type pixels and data collected by the plurality of second type pixels.

Also in accordance with the disclosure, there is provided an image acquisition method including determining an operation mode of an image acquisition apparatus including a plurality of first type pixels and a plurality of second type pixels, and performing calculation using at least data selected from the group including data collected by the plurality of first type pixels and data collected by the plurality of second type pixels according to the operation mode of the image acquisition apparatus. The plurality of first type pixels and the plurality of second type pixels are different from each other and implement different functions

### BRIEF DESCRIPTION OF THE DRAWINGS

In order to provide a clear understanding of the present disclosure, the drawings used in the description of the disclosed embodiments or the conventional technologies are briefly described below.

FIG. 1 is a schematic diagram showing an example of image acquisition apparatus according to the disclosure.

FIG. 2 is a schematic diagram showing a photosensitive array of a conventional image acquisition apparatus.

FIG. 3 is a schematic diagram showing a photosensitive array and an arrangement of first type pixels and second type pixels of an image acquisition apparatus consistent with the disclosure.

FIGS. 4A and 4B schematically show other examples of arrangement of the first type pixels and the second type pixels according to the disclosure.

FIG. 5 is a schematic diagram showing a photosensitive array in another image acquisition apparatus consistent with the disclosure.

FIG. 6 is a flow chart of an image acquisition method according to the disclosure.

FIG. 7 is a block diagram of an electronic device according to the disclosure.

FIG. 8 is a block diagram of another electronic device according to the disclosure.

### DETAILED DESCRIPTION

Hereinafter, embodiments of the present disclosure are described with reference to the drawings. It is apparent that the described embodiments are merely examples, and are not intended to limit the scope of the present disclosure. Furthermore, the structures and technologies that are known by those skilled in the art are omitted in the following description to avoid any confusion of the concepts of the present disclosure.

The terms in the specification, claims, and the drawings of the present disclosure are merely used to illustrate embodiments of the present disclosure, instead of limiting the present disclosure. Unless otherwise defined, the terms “one,” “a,” “the,” or the like are meant to encompass “multiple,” “a plurality of,” or the like. In addition, the terms “including,” “comprising,” and variants thereof herein are open, non-limiting terminologies, which are meant to encompass a series of elements of features, processes, operations, and/or components. Not only those elements, but also one or more elements that are not explicitly listed, or one or more elements that are inherent to such features, processes, operations, and/or components may be included. In the absence of more restrictions, the elements defined by the statement “including a . . . ” do not preclude the presence of additional elements in the features, processes, operations, and/or components including the elements.

Unless otherwise defined, all the technical and scientific terms used herein have the same or similar meanings as generally understood by one of ordinary skill in the art. It is apparent that the terms used herein have the meanings consistent with the context of the specification and should not be interpreted in an idealized or overly stereotypical manner.

It is apparent that some blocks in the block diagrams and/or flowcharts shown in the drawings, or combinations thereof, can be implemented by computer program instructions. The computer program instructions can be executed by a processor of a general-purpose computer, a special-purpose computer, or another programmable data processing apparatus, such that the processor can implement the functions/operations illustrated in the block diagrams and/or flowcharts.

Those of ordinary skill in the art will appreciate that a method consistent with the present disclosure can be implemented in electronic hardware and/or computer software. In addition, a method consistent with the disclosure can be implemented in the form of computer program stored in a non-transitory computer-readable storage medium, which can be sold or used as a standalone product. The computer program product can be used by or in connection with an instruction execution system. The computer-readable storage medium can be any medium that can contain, store, transfer, transmit, or propagate the instructions. For example, the computer-readable storage medium can include, but is not limited to, electrical, magnetic, optical, electromagnetic, infrared, or semiconductor systems, apparatus, device, or propagation media. The computer-readable storage medium can include, for example, a magnetic storage device, such as a magnetic disk or a hard disk (HDD), an optical storage device, such as a compact disks (CD-ROMs), a memory, such as a random access memory (RAM) or a flash memory, and/or a wired or wireless communication links.

In accordance with the disclosure, there is provided an image acquisition apparatus that includes a lens and a photosensitive array. The photosensitive array comprises a plurality of pixels that include at least a plurality of first type pixels and a plurality of second type pixels that are different from the first type pixels. The first type pixels are at least configured to perform display output and the second type pixels are configured to implement a specific function that is different from the function of the first type pixels. As such, multiple functions can be achieved by a single image acquisition apparatus. In addition to the image display output, other functions can be realized by, for example, using data collected by the second type pixels, i.e., pixel values of the second type pixels.

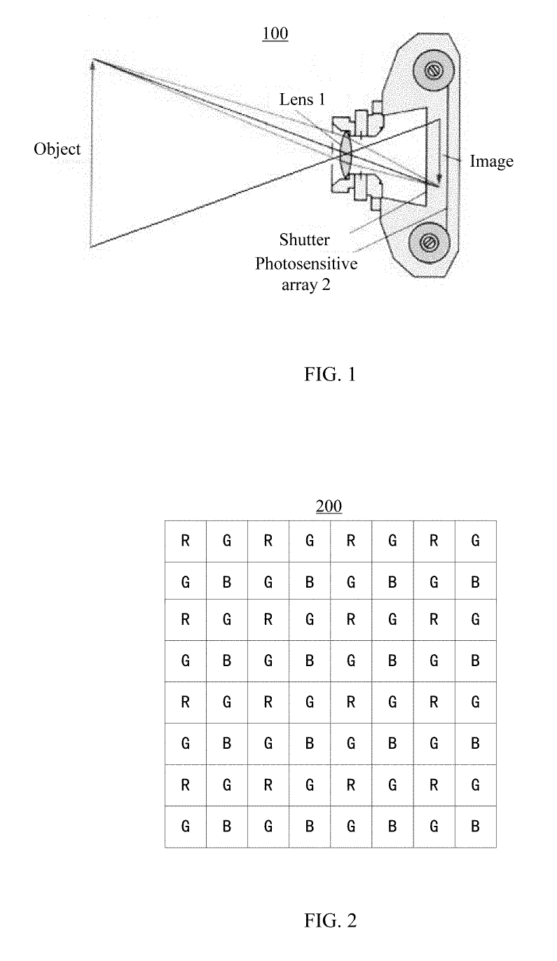

FIG. 1 is a schematic diagram showing an example image acquisition apparatus 100 consistent with the disclosure.

As shown in FIG. 1, the image acquisition apparatus 100 includes a lens 1 and a photosensitive array 2. The lens 1 is configured to collect light and adjust the path of light, such that a maximum amount of light can be incident on the photosensitive array 2 that is behind the lens 1. The photosensitive array 2 is configured to sense the light incident thereon. The photosensitive array 2 can include, for example, a charge-coupled device (CCD) sensor or a complementary metal-oxide-semiconductor (CMOS) sensor. The CCD sensor is made of high-light-sensitive semiconductor materials, which can convert light into electric charges that can be turned into digital signals through an analog-to-digital (AD) converter. A CCD can include a plurality of photosensitive units, such as millions of pixels. When light incidents on the CCD surface, each photosensitive unit can produce corresponding electronic charges, and signals generated by multiple photosensitive units can form an image. The photosensitive array of the image acquisition device consistent with the disclosure includes, but is not limited to, all kinds of the existing sensors. Other materials having the photosensitive function, including those to be developed in the future, are also applicable.

FIG. 2 is a schematic diagram showing an example photosensitive array 200 in a conventional image acquisition apparatus consistent with the disclosure.

As shown in FIG. 2, the photosensitive array 200 includes a plurality of pixels and each pixel senses a corresponding color. For example, each pixel senses red (R), green (G), or blue (B).

When the display output is performed, an image can be acquired by obtaining pixel values of various pixels and performing a corresponding calculation. The image can be outputted for displaying on a display screen of the image acquisition apparatus 100.

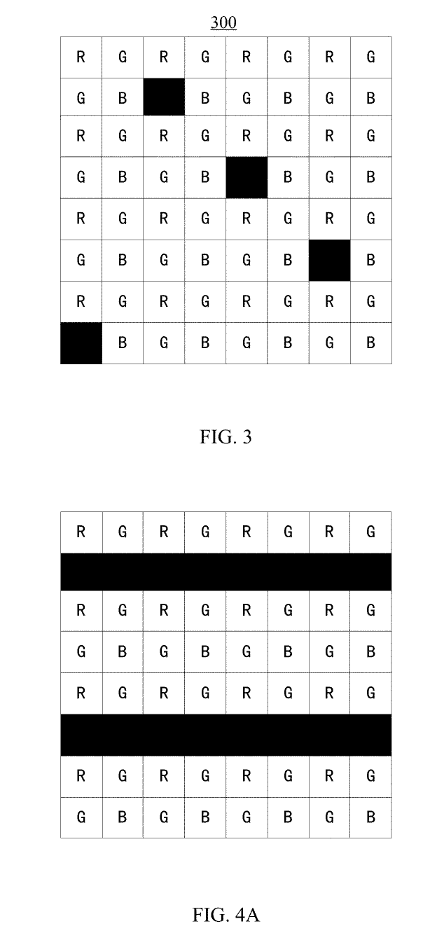

FIG. 3 is a schematic diagram showing an example photosensitive array 300 of an image acquisition apparatus consistent with the disclosure.

As shown in FIG. 3, the photosensitive array 300 includes a plurality of pixels. The plurality of pixels at least include the first type pixels and the second type pixels that are different from the first type pixels. As shown in FIG. 3, the first type pixels include the pixels that sense the corresponding colors, for example, red color, green color, and blue color (referred to as red pixels, green pixels, and blue pixels, respectively, and labeled as R, G, and B, respectively, in the figures), and the second type pixels are denoted as black boxes in the figure.

Compared to the photosensitive array 200 shown in FIG. 2, some green pixels of the photosensitive array 300 shown in FIG. 3 are replaced by the second type pixels, denoted as black boxes.

In some embodiments, the first type pixels can be configured to perform the display output and the second type pixels can be configured to perform a specific function that is different from the function of the first type pixels.

In some embodiments, the first type pixels can include visible-light pixels and the second type pixels can include non-visible-light pixels. That is, the first type pixels can sense visible light (i.e., light having wavelengths that are visible to human eyes) and the second type pixels can sense non-visible light (i.e., light having wavelengths that are non-visible to human eyes). In some embodiments, each pixel can include a photosensitive element and a coating film. The photosensitive element can be configured to detect the light incident thereon after passing through the coating film. The coating film of a first type pixel can be configured to filter out non-visible light. In some embodiments, the coating film of a first type pixel can be configured to transmit only light of a specific color, i.e., to allow light of a specific color (wavelength(s)) to pass through. For example, for the pixels used for capturing red light, the coating film thereon can transmit only light of red wavelength. For the pixels used for capturing green light, the coating film thereon can transmit only light of green wavelength. For the pixels used for capturing blue light, the coating film thereon can transmit only light of blue wavelength. The coating film of the second type pixel can be configured to filter out visible light and transmit non-visible light having specific wavelength(s).

In some embodiments, the first type pixels can be arranged according to a first layout and the second type pixels can be arranged according to a second layout. The second layout can be that the second type pixels are symmetrically and uniformly distributed in the photosensitive array 300 and the second type pixels are surrounded by the first type pixels, for example, a second type pixel is surrounded by a plurality of first type pixels.

FIG. 3 schematically shows an example arrangement of the first type pixels and the second type pixels consistent with the disclosure. As shown in FIG. 3, multiple green pixels of the first type pixels are replaced by the second type pixels.

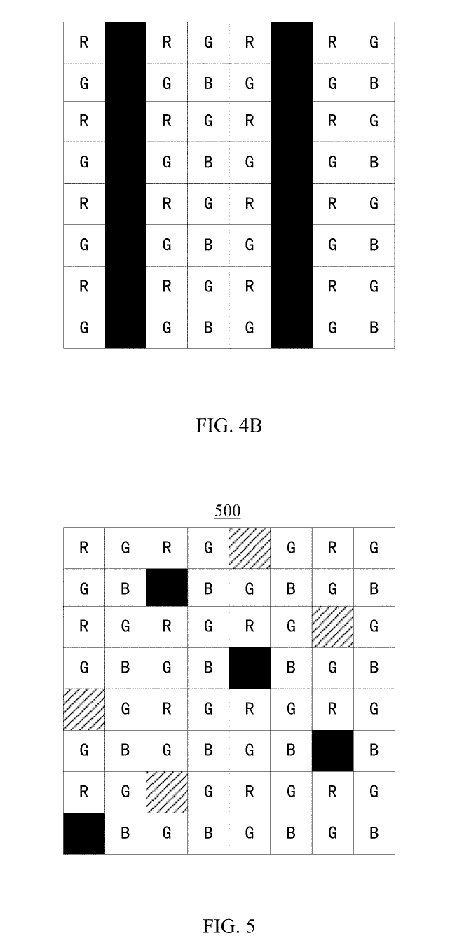

FIGS. 4A and 4B schematically show other arrangements of the first type pixels and the second type pixels consistent with the disclosure.

In some embodiments, as shown in FIG. 4A, one row of second type pixels is inserted for every preset number of rows. In some other embodiments, as shown in FIG. 4B, one column of second type pixels is inserted for every preset number of columns.

It is apparent that the arrangement of the first type pixels and the second type pixels consistent with the disclosure is not limited to the described embodiments. Other arrangements that do not affect the realization of at least two functions of the image acquisition apparatus can be also applicable.

In some embodiments, when the image acquisition apparatus is configured to perform the display output, the calculation can be implemented using only data collected by the first type pixels, i.e., pixel values of the first type pixels. In this situation, the second type pixels can be treated as dead pixels. The dead pixels can be compensated using the data collected by the first type pixels surrounding the second type pixels. That is, the value of a second type pixel, i.e., a dead pixel, can be calculated from the data collected by the first type pixels surrounding the second type pixel. For example, as shown in FIG. 3, the pixel value of the second type pixel in the second row can be compensated by the first type pixels in the upper right and lower left positions thereof.

In some embodiments, when the image acquisition apparatus is configured to implement a specific function other than the display output function, the calculation can be implemented using only data collected by the second type pixels.

For example, the second type pixels can be used for range measurement. In this situation, the image acquisition apparatus can also be used as a range measurement apparatus.

Taking an infrared range camera as an example, when the image acquisition apparatus is provided on, for example, a portable device, an infrared emitter is also provided on the portable device. When range measurement function is needed, the infrared emitter emits infrared light to a target object to be measured and the second type pixels of the image acquisition apparatus acquire reflected infrared light (i.e., infrared light that is reflected by the target object). The distance to the target object can be obtained by calculating a time difference between a time the infrared light is emitted by the emitter and the reflected infrared light is received by the receiver (i.e., the second type pixels).

It is apparent that the image acquisition apparatus consistent with the disclosure can also implement other types of range camera, such as a range camera implementing the range measurement using another wavelength.

In some embodiments, the second type pixels can sense non-visible light having a wavelength of about 940 nm, which is commonly used for range measurement.

The range measurement does not need too many pixels. In general, 500,000 to 1 million pixels can meet the need of the range measurement. Currently, an image acquisition apparatus usually has tens of millions of pixels. Therefore, in some embodiments, the number of the second type pixels does not exceed 10% of the total number of pixels. As the resolution of the image acquisition apparatus becomes higher and higher, the percentage of the second type pixels to the total number of pixels can be even smaller, for example, less than 1%.

As another example, the second type pixels can be used for iris recognition.

In this situation, the image acquisition apparatus can be placed close to an eye of a target individual to be identified. The image acquisition apparatus is provided on, for example, a portable device, and an infrared emitter provided on the portable device can emit infrared light. The infrared light that is incident on the iris can cause the iris to contract. The second type pixels of the image acquisition apparatus can continuously capture images, such that the image acquisition apparatus can capture the contraction of the iris. In some embodiments, the subsequent expansion of the iris can also be detected. A series of iris images can be used to calculate characteristic parameters of the iris of the target individual. The target individual can be recognized by comparing the calculated characteristic parameters with pre-stored characteristic parameters.

According to the present disclosure, the number of second type pixels may be large enough to ensure the accuracy of iris recognition. The first type pixels and the second type pixels can be arranged reasonably, such that the image acquisition apparatus can realize both the display output and the iris recognition.

In some embodiments, the image acquisition apparatus can also include a third type pixels. For example, the first type pixels can be configured to perform the display output, the second type pixels can be configured to implement range measurement, and the third type pixels can be configured to implement iris recognition. In this situation, the coating films on various pixels are configured to transmit light having corresponding wavelengths, respectively. For example, the first type pixels can be configured to collect visible light, the second type pixels can be configured to collect light having wavelength(s) for range measurement, and the third type pixels can be configured to collect infrared light. When the image acquisition apparatus is configured to perform the display output, the calculation can be performed using only data collected by the first type pixels. When the image acquisition apparatus is configured to implement the range measurement, only data collected by the second type pixels is used for processing. When the image acquisition apparatus is configured to implement the iris recognition, only data collected by the third type pixels is used for processing. The first type pixels, the second type pixels, and the third type pixels are respectively connected to backend processing circuit(s) for processing data collected by the corresponding pixels, when the corresponding functions are implemented, so as to achieve the required functions.

FIG. 5 is a schematic diagram showing an example photosensitive array 500 in another image acquisition apparatus consistent with the disclosure. Comparing to the photosensitive array 300 shown in FIG. 3, the photosensitive array 500 shown in FIG. 5 also includes the third type pixels that are denoted by boxes with diagonal lines in the figure. The first type pixels, the second type pixels, and the third type pixels can be arranged reasonably, such that the image acquisition apparatus can realize the display output, the range measurement, and the iris recognition.

In some embodiments, the specific function realized by the second type pixels can provide supplementary information for the image outputted by the first type pixels. For example, the first type pixels can be configured to implement imaging of an object and the second type pixels can be configured to implement the range measurement to obtain a range parameter of the object. The outputted image can be stored with the corresponding range parameter, such that a user can easily acquire distance information of the object.

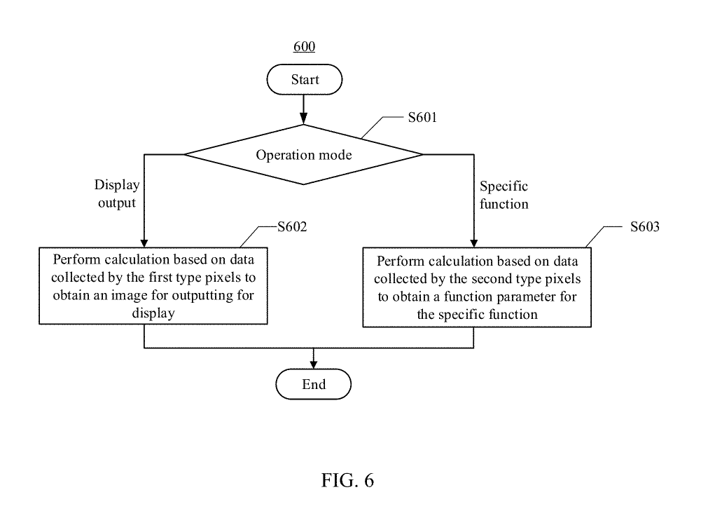

FIG. 6 is a flow chart of an example method 600 using the image acquisition apparatus consistent with the disclosure.

As shown in FIG. 6, at S601, the operation mode of the image acquisition apparatus is determined. In some embodiments, when the image acquisition apparatus is configured to perform the display output, the method 600 proceeds to the process at S602. In some other embodiments, when the image acquisition apparatus is configured to implement a specific function, the method 600 proceeds to the process at S603.

At S602, calculation is performed based on data collected by the first type pixels to obtain an image for outputting for display.

At S603, calculation is performed based on data collected by the second type pixels to obtain a function parameter for the specific function. For example, when the second type pixels are configured to implement the range measurement, the range parameter of a target object can be obtained.

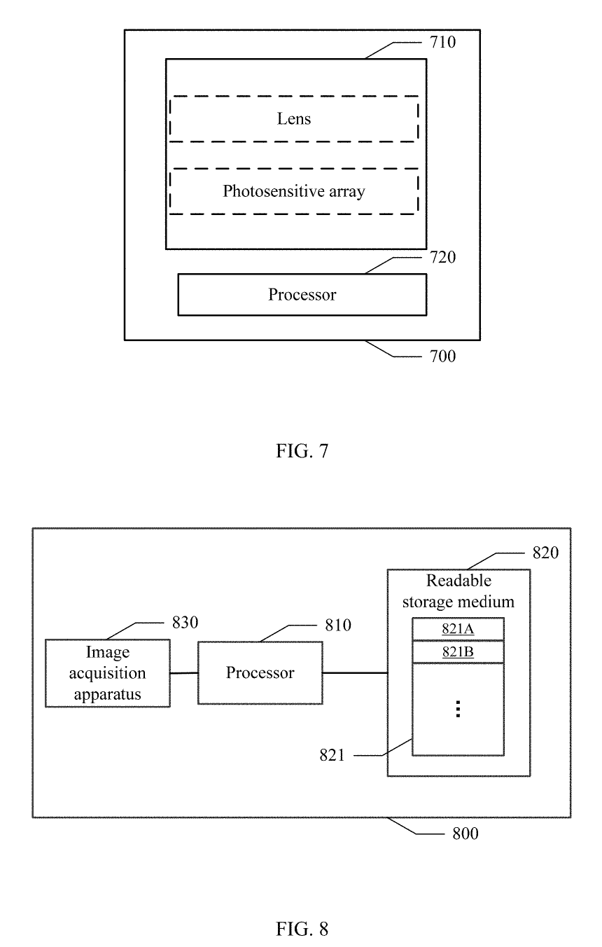

FIG. 7 is a block diagram of an example electronic device 700 consistent with the disclosure.

As shown in FIG. 7, the electronic device 700 includes an image acquisition apparatus 710 and a processor 720. The image acquisition apparatus 710 includes a lens and a photosensitive array. The photosensitive array includes at least the first type pixels and the second type pixels. In some embodiments, the first type pixels can be configured to perform the display output, and the second type pixels can be configured to implement a specific function other than the function of the first type pixels.

The processor 720 is configured to control the image acquisition apparatus 710 and realize a function required by the electronic device 700 using the image acquisition apparatus 710. For example, when the image acquisition apparatus 710 is configured to perform the display output, the processor 720 can be configured to implement a calculation using data collected by the first type pixels of the image acquisition apparatus 710 to obtain an image for display. When the image acquisition apparatus is configured to implement the specific function, such as the range measurement, the processor 720 can be configured to implement a calculation using data collected by the second type pixels of the image acquisition apparatus 710 to obtain a function parameter of the specific function.

In some embodiments, the electronic device 700 can also include other apparatuses, such as an infrared emitter, a display screen, and/or the like. The detailed description of the other modules are omitted here.

Those of ordinary skill in the art will appreciate that the processor 720 can be at least partially implemented by electronic hardware, such as, for example, a Field-Programmable Gate Array (FPGA), a Programmable Logic Array (PLA), a System-on-Chip (SoC), a System-on-Substrate (SoS), a System-in-Package (SiP), an Application Specific Integrated Circuit (ASIC), or any other hardware or firmware that includes integrated or packaged circuits. In some embodiments, the processor 720 can also be implemented by any suitable combination of computer software, electronic hardware, and firmware. In some embodiments, the processor 720 can at least partially run a computer program that to perform a corresponding function.

FIG. 8 is a block diagram of another example electronic device 800 consistent with the disclosure.

As shown in FIG. 8, the electronic device 800 includes a processor 810, a computer-readable storage medium 820, and an image acquisition apparatus 830. The electronic device 800 can implement an image acquisition method consistent with the disclosure, such as the method 600 shown in FIG. 6, to realize multiple functions.

In some embodiments, the processor 810 can include, for example, a general-purpose microprocessor, an instruction-set processor and/or related chipsets, a special-purpose microprocessor (e.g., an application specific integrated circuit (ASIC)), and/or the like. In some embodiments, the processor 810 can further include an on-board memory for caching. In some embodiments, the processor 810 can include a single processing unit or a plurality of processing units for implementing other processes that are different from the processes of the method 600 shown in FIG. 6.

The computer-readable storage medium 820 can be any medium that can, for example, contain, store, transfer, transmit, or propagate the instructions. For example, the computer-readable storage medium can include, but is not limited to, electrical, magnetic, optical, electromagnetic, infrared, or semiconductor systems, apparatus, device, or propagation media. In some embodiments, the computer-readable storage medium 820 can include, for example, a magnetic storage device, such as a magnetic disk or a hard disk (HDD), an optical storage device, such as a compact disks (CD-ROMs), a memory, such as a random access memory (RAM) or a flash memory, and/or a wired or wireless communication links.

In some embodiments, the computer-readable storage medium 820 can further include a computer program 821 including codes/computer-executable instructions. The codes/computer-executable instructions, when executed by the processor 810, can cause the processor 810 to implement an image acquisition method consistent with the disclosure, such as the method 600 shown in FIG. 6 or a variant thereof.

In some embodiments, the computer program 821 can be configured to include, for example, one or more computer program modules, such as program module 821A, program module 821B, and/or the like. In some embodiments, the module 821A, when executed by the processor 810, can cause the electronic device 800 to determine an operation mode of the image acquisition apparatus 830. The module 821B, when executed by the processor 810, can cause the electronic device 800 to achieve a desired function, for example, the display output, the range measurement, or the like, using the image acquisition apparatus 830.

It should be understood that the division manner and number of the program modules are not fixed, and those skilled in the art can use any suitable program modules or the combination of program modules according to the actual situation. The combination of program modules, when executed by the processor 810, can cause the processor 810 to implement an image acquisition method consistent with the disclosure, such as the method 600 shown in FIG. 6 or a variant thereof.

In some embodiments, the processor 810 can interact with the image acquisition apparatus 830 to perform an image acquisition method consistent with the disclosure, such as the method 600 shown in FIG. 6 or a variant thereof.

It will be apparent to those skilled in the art that the embodiments disclosed in the specification and/or the features described in the claims can be combined or integrated in various manner, no matter whether or not such combination or integration are explicitly described in the present disclosure. Any combination or integration of the embodiments disclosed in the specification and/or the features described in the claims without departing from the spirit is falling into the scope of the disclosure.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. An image acquisition apparatus comprising:
a lens; and
a photosensitive array including at least a plurality of first type pixels and a plurality of second type pixels, wherein the plurality of first type pixels and the plurality of second type pixels are different from each other and implement different functions.

2. The apparatus according to claim 1, wherein:
the plurality of first type pixels perform a display output function; and
the plurality of second type pixels perform a specific function that is different from the display output function.

3. The apparatus according to claim 1, wherein:
the plurality of first type pixels sense visible light; and
the plurality of second type pixels sense non-visible light.

4. The apparatus according to claim 3, wherein:
the plurality of second type pixels include coating films that filter out visible light and transmit non-visible light.

5. The apparatus according to claim 1, wherein the plurality of second type pixels are arranged symmetrically and uniformly in the photosensitive array and are surrounded by the plurality of first type pixels.

6. The apparatus according to claim 1, wherein:
in response to the image acquisition apparatus performing a function corresponding to the plurality of first type pixels, only data collected by the plurality of first type pixels is used for calculation.

7. The apparatus according to claim 1, wherein:
in response to the image acquisition apparatus performing a function corresponding to the plurality of second type pixels, only data collected by the plurality of second type pixels is used for calculation.

8. An electronic device comprising:
an image acquisition apparatus including:
a lens; and
a photosensitive array including at least a plurality of first type pixels and a plurality of second type pixels, wherein the plurality of first type pixels and the plurality of second type pixels are different from each other and implement different functions; and
a processor coupled to the image acquisition apparatus, wherein the processor performs calculation using at least data selected from the group including data collected by the plurality of first type pixels and data collected by the plurality of second type pixels.

9. The electronic device according to claim 8, wherein:
the plurality of first type pixels perform a display output function; and
the plurality of second type pixels perform a specific function that is different from the display output function.

10. The electronic device according to claim 8, wherein:
in response to the image acquisition apparatus performing the display output function, the processor performs the calculation using only the data collected by the plurality of first type pixels to obtain an image; and
in response to the image acquisition apparatus performing the specific function, the processor performs the calculation using only the data collected by the plurality of second type pixels to obtain a function parameter of the specific function.

11. The electronic device according to claim 8, wherein:
the plurality of first type pixels sense visible light; and
the plurality of second type pixels sense non-visible light.

12. The electronic device according to claim 8, wherein the plurality of second type pixels are arranged symmetrically and uniformly in the photosensitive array and are surrounded by the plurality of first type pixels.

13. An image acquisition method comprising:
determining an operation mode of an image acquisition apparatus including a plurality of first type pixels and a plurality of second type pixels; and
performing calculation using at least data selected from the group including data collected by the plurality of first type pixels and data collected by the plurality of second type pixels according to the operation mode of the image acquisition apparatus,
wherein the plurality of first type pixels and the plurality of second type pixels are different from each other and implement different functions.

14. The method according to claim 13, wherein performing the calculation includes:
in response to the operation mode of the image acquisition apparatus being performing a display output function, performing the calculation using the data collected by the plurality of first type pixels to obtain an image for outputting for display.

15. The method according to claim 13, wherein performing the calculation includes:
in response to the operation mode of the image acquisition apparatus being performing a specific function that is different from a display output function, performing the calculation using the data collected by the plurality of second type pixels to obtain a function parameter for the specific function.
